(19) United States
(12) Patent Application Publication
(10) Pub. No.: US 2026/0225398 A1
(43) Pub. Date: Aug. 6, 2026

(54) ANTI-GRAFFITI SYSTEM

(71) Applicant: MATRYX PTY LTD, Hawthorn (AU)

(72) Inventor: Luke Richard PERCY-DOVE, Doncaster (AU)

(21) Appl. No.: 19/155,155

(22) PCT Filed: Feb. 20, 2024
(86) PCT No.: PCT/AU2024/050122

§ 371 Date: Aug. 8, 2025

(30) Foreign Application Priority Data
Feb. 27, 2023 (AU) 2023900497

(51) Int. Cl. B44D 5/00; B28B 7/00; B44F 5/00

(52) U.S. Cl. CPC B44D 5/00; B28B 7/0064; B44F 5/00

(57) ABSTRACT

A method of minimising the risk of graffiti despoiling a surface by applying either (a) a pre-printed waterproof vinyl sheet having a plurality of multi-coloured pixels (as herein defined) of different colours, so that any subsequent application of graffiti to that painted surface will render the applied graffiti as not or not very visible or legible, as the outline of the graffiti will blend in with at least some of the coloured pixels thereby detracting from the visibility or legibility of the graffiti, or (b) applying one or more tiles 40 having pre-formed 3D pixels 41, 42, 43 capable of rendering any subsequently applied graffiti as not or not very visible or legible, as the outline of the graffiti will be hidden by the peaks 41 or valleys 43 in the exterior surface of the tile(s).

### FIELD OF THE INVENTION

This invention relates to the field of graffiti prevention and management, specifically a method of deterring graffiti artists from tagging structures, buildings or other objects.

### BACKGROUND

Graffiti is a significant problem that affects the aesthetics, safety, and value of buildings and infrastructure in many urban areas. Traditional anti-graffiti methods, such as cleaning and protective films, have limitations in terms of cost, effectiveness, and the ability to discourage or eliminate graffiti.

Therefore, there is a need for a new and effective anti-graffiti solution that can reduce the impact of graffiti and discourage or eliminate its occurrence.

### PROBLEM

Graffiti in the form of tags, or tagging is a problem for buildings, walls, and other objects presenting a large flat usually monochrome surface to serve as a backdrop for a graffiti. These are usually spray-painted using a single colour, though more elaborate graffiti is sometimes multi-coloured. The intention is to provide a visible mark, identifying a gang or other group, or in some cases, an individual who wishes to leave his or her mark on buildings or other objects. In order to be visible, most tags are at least 300 mm high and 200 mm wide, so that they can be viewed from some distance either straight on or at a wide range of angles. For example, a single letter of a tag on a railway overbridge, may well be more than a metre high by a least half a metre wide, so that they can be seen from a train, or adjoining roadway. One example of graffiti on a wall displayed a word with chunky letters spanning an area 2 m high by 12 m long.

Various attempts have been made to minimise or deter the application of graffiti including:
(a) special cleaning materials to remove sprayed on graffiti (e.g. US11692107 provides a cleaning formulation); or
(b) special coatings that make it difficult for the spray paint to adhere, or at least make it easier to wash off the spray-painted tag; or
(c) a motion detector and sprinkler system as in US20210101166 to wet the graffiti artist; or
(d) providing a plurality of peel off layers that can be used to cover a vulnerable area and then removed one at a time to dispose of graffiti, but this provides a new clean flat surface with the result that new graffiti may be applied to it.

None of these have proved to be effective, and tagging of public buildings and other objects is a continuing problem and a significant cost to the owners. Building owners often resort to over painting the surface, with a fresh single colour, to conceal the tag, which then leaves a fresh surface to be re-painted by a tagger.

### PRIOR REFERENCES

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications may be referred to herein; this reference does not constitute an admission that any of these documents form part of the common general knowledge in the art, in Australia or in any other country.

### OBJECT OF THE INVENTION

It is an object of the invention to provide an anti-graffiti system that ameliorates some of the disadvantages and limitations of the known art or at least provide the public with a useful choice.

### SUMMARY OF INVENTION

The Inventive concept proposes using multi-coloured, or multi-shaped camouflage “artwork” to cover the surface of buildings, infrastructure, and other objects to reduce the visibility of any subsequently applied tag.

In one aspect the invention provides a method of minimising the risk of graffiti despoiling a surface, the method, including reducing the available area for graffiti by applying pixels (as herein defined) to the surface.

Preferably the method involves affixing a waterproof layer to the surface to be protected, the waterproof layer having pre-applied pixels (as herein defined) on the exterior surface thereof.

Preferably the pixels provide a multi-coloured coating to the surface, made up of coloured pixels (as herein defined) of different colours, so that the application of graffiti to that painted surface will render the applied graffiti as not or not very visible or legible, as the outline of the graffiti will blend in with at least some of the coloured pixels thereby detracting from the visibility or legibility of the graffiti.

Preferably the majority of pixels are of a different colour to the majority of its adjoining pixels.

Preferably the colours of each pixel are chosen at random.

Preferably the coloured pixels are applied to a waterproof backing sheet which can be applied to a surface of a building or other object.

Preferably the waterproof backing sheet has a self-adhesive layer to allow it to be easily secured to the surface.

Alternatively the applied pixels are three-dimensional thereby breaking up the flat surface area of the object to render any applied graffiti as not or not very visible or legible.

Preferably the majority of pixels have a minimum area of 200 sq. mm.

Preferably the majority of pixels are between 200 sq. mm and 10,000 sq. mm in area.

In another aspect the invention provides a building or other object protected by coloured pixels or 3D pixels applied by the method of any preceding claim.

In another aspect the invention provides a product designed to minimise the risk of graffiti despoiling a surface consisting of a waterproof layer to be applied to structure to be protected, the layer having a pre-prepared exposed/external surface designed to reduce the legibility/visibility of any applied graffiti.

Preferably the layer is a flexible plastics layer pre-printed with coloured pixels (as herein defined).

Preferably the flexible plastics layer has a self-adhesive backing.

Optionally the layer is a tile having three-dimensional pixels (as herein defined) thereon.

Preferably the tile is formed of a rigid or semi-rigid plastics material, or it could be made of a composite material, or of metal, or a ceramic or a concrete.

Preferably the three-dimensional pixels (as herein defined) are also coloured.

Preferably a majority of the 3D pixels (as herein defined) have exterior surfaces at an angle to adjacent pixels.

Preferably the majority of pixels have a minimum area of 200 sq. mm.

Preferably the majority of pixels are between 200 sq. mm and 10,000 sq. mm in area.

Preferably the product is a cast concrete panel having a moulded exterior surface having three-dimensional pixels thereon.

In another aspect the invention provides a mould for a pre-cast panel having a negative pattern of a cluster of three-dimensional pixels capable of being used to cast a panel having a cluster of three-dimensional pixels on an exterior surface thereof.

Preferably the mould is used to produce a panel of a rigid or semi-rigid plastics material, or it could be a panel of composite material, or of metal, or a ceramic or a concrete.

### BRIEF DESCRIPTION OF DRAWINGS

The invention will now be described, by way of example only, by reference to the accompanying black and white drawings:

FIG. 1 illustrates an electrical infrastructure surface with graffiti tags.

FIG. 2 illustrates the use of Inventive concept artwork to reduce the visibility of graffiti tags.

FIG. 3 illustrates an example of camouflage artwork when applied to an electrical infrastructure.

FIG. 4 illustrates another example of camouflage artwork 13 when applied to an electrical infrastructure.

FIGS. 5-7 illustrates the camouflage concept by using coloured cells in a spreadsheet.

FIG. 8 shows randomly coloured square pixels.

FIG. 9 shows an example of a wall covered with 3D shapes with sloping surfaces to reduce the available surface area for graffiti.

FIG. 10 shows an example of a wall covered with 3D shapes of different hights to reduce the available surface area for graffiti.

FIG. 11 shows a moulded 3D tile in perspective view having an irregular collection of 3D shapes.

FIG. 12 is a top plan view of the tile of FIG. 11.

FIG. 13 is a first side view of the tile of FIG. 11.

FIG. 14 is a second side view of the tile of FIG. 12, taken at 90° to the side view of FIG. 13.

Because of the nature of graffiti, the drawings in the priority document (an Australian provisional specification 2023900497) were shown in colour. As coloured drawings are not permitted in a PCT application we have endeavoured to represent the effect of colour in the attached black and white drawings. To appreciate the effect of colour, reference may be made to the following website which provides good examples of prior art coloured graffiti: https://www.5280.com/how-to-decipher-denvers-graffiti-street-art/ And to the following Dropbox which contains copies of the coloured drawings appearing in the priority document: https://www.dropbox.com/scl/fo/vlhvh4kko6w8xidwhz8ml/h?rlkey=alt4m0g2hsqgonagy2ieul1po&dl=0

### Definitions:

“Artwork” in the context of this invention refers to collections of pixels whether coloured or 3D used to minimise the risk of graffiti being applied to a surface, irrespective of artistic quality (if any). In effect the 2D version is similar to coloured print or painting whereas the 3D version is similar to a work of sculpture.

“Comprise”. It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e., that it will be taken to mean an inclusion of not only the listed components it directly references, but also other non-specified components or elements. This rationale will also be used when the term ‘comprised’ or ‘comprising’ is used in relation to one or more steps in a method or process. “Contoured” refers to the 3D effect of hills and valleys and other shapes on the surface of a tile or a wall.

“Exterior surface” in the context of this invention means the surface of the layer visible to the public (when the layer is affixed to a surface to be protected).

“Graffiti” is a form of visual communication, usually illegal. Typically it involves writing or marks or drawings usually from a spray can. Though it can be scribbled, scratched, painted or sprayed illicitly on a wall or other surface in a public place. Often they are in the form of initials or a logo or a word sometimes denoting an individual tagger or sometimes membership in a gang or other organisation.

“Tag” is the popular name for such graffiti.

“Tagging,” refers to the repeated use of a single symbol or series of symbols to mark territory. In order to attract the most attention possible, this type of graffiti usually appeared in strategically or centrally located neighbourhoods.

“Tagging surface” means the available backdrop for a tag.

“Object” in the context of this invention is used to generally denote a building, wall, box, or visible infrastructure.

“Pixels” in the context of this invention refers to coloured blobs or 3D shapes each of which is small relative to the overall coverage of the building or other object to be protected.

### DESCRIPTION OF THE PREFERRED EMBODIMENT(S)

The following description will describe the invention in relation to preferred embodiments of the invention, namely an anti-graffiti system The invention is in no way limited to these preferred embodiments as they are purely to exemplify the invention only and that possible variations and modifications would be readily apparent without departing from the scope of the invention.

By using a plurality of different coloured blobs or pixels to create an attractive backdrop, the artwork renders any subsequent application of a tag to be illegible, as the single colour of the tag will blend in with some of the coloured pixels, thereby interrupting the letters or lines of the tag.

The method of creating or applying or affixing the artwork involves the creation of a multi-coloured backdrop or image where practical and to limit the use of solid areas of colour in the artwork. It should also contain shapes and other elements that would further disguise any graffiti if the artwork were to be vandalised. The artwork can be created in any size and still be logical in its representation.

In one form of the invention the artwork is applied to self-adhesive sheets which can be attached to eh exterior surface of a building or wall or other object.

The Inventive concept is scalable, so that it can also be applied to very large surfaces and may be by way of stencils or templates that simplify the application of the artwork onto very large areas quickly and far more cost-effectively than custom artworks.

The method of this invention and the products of this invention create backgrounds that will naturally “camouflage” the tagging, thus reducing the motivation to graffiti the object. The Inventive concept is designed to discourage or eliminate graffiti and is intended to contribute positively to the amenity of the local area.

By using a plurality of different coloured blobs or pixels to create an attractive backdrop, we have found that this renders any subsequent application of a tag to be illegible, as the single colour of the tag will blend in with some of the coloured pixels, thereby interrupting the letters or lines of the tag.

Preferably the colour of the pixels or blobs are chosen from the colour palette of available spray, paint cans, as these are the most likely colours to be used by Taggers.

Because spray paint cans are the weapon of choice by taggers, some stores place a restriction on the sale of spray paint cans, to help reduce the accessibility of these cans to taggers. But clearly this has not been successful because taggers still are able to obtain spray paint cans to leave their mark on public buildings and other objects.

The other way of reducing the available surface to be used by taggers, is to use pixels of one or more 3D protrusions or depressions (called “3D artworks”) to break up the available surface, which would otherwise be used by a tagged. The 3D artworks can be modular e.g.: 1 m×1 m in area so they can be scaled and connected and applied to any surface of any size.

In the following detailed description, reference is made to the accompanying drawings, which form a part hereof. In the drawings, similar symbols typically identify similar components, unless context dictates otherwise.

### PRIOR ART

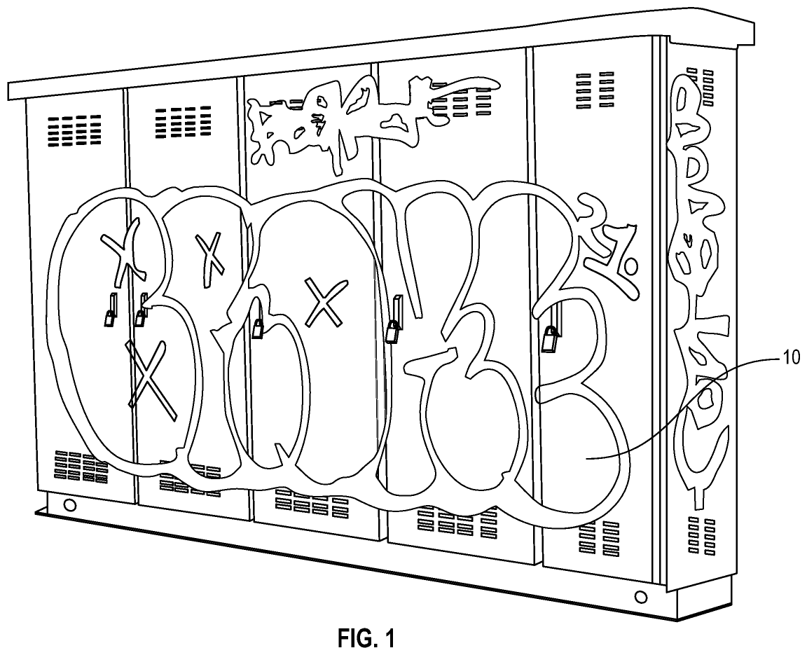

FIG. 1 is indicative of the problem to be solved or deterred. It illustrates a typical monochrome building surface with graffiti tags 10. As shown, the tags are large and easily visible and detract from the appearance of the building. The graffiti is approximately 1 m high and about 2.5 m wide.

### EXAMPLE 1

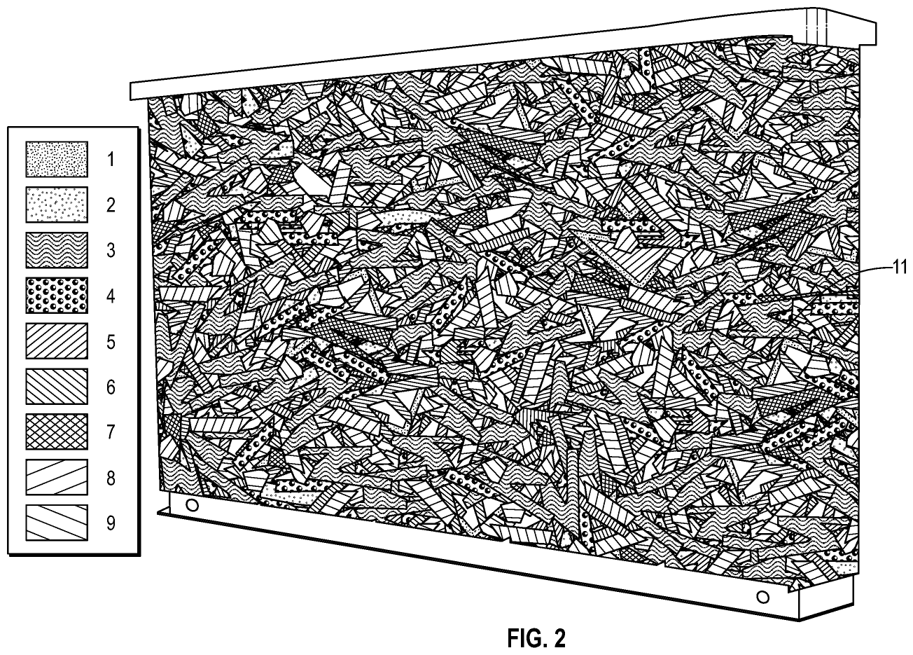

FIG. 2 illustrates the use of Inventive concept artwork to reduce the visibility of future graffiti. As shown, the multi-coloured (each colour being represented by a different shading) camouflage artwork 11 covers the surface of a utility box, creating a backdrop that renders any subsequent application of a tag to be illegible/less visible. In this example the pixels are of different sizes and shapes, though of smaller size than many of the following examples. The overall effect could be considered to be a more abstract version of the style of an aboriginal painting with colours such as orange, red, white, blue and green being used.

### EXAMPLE 2

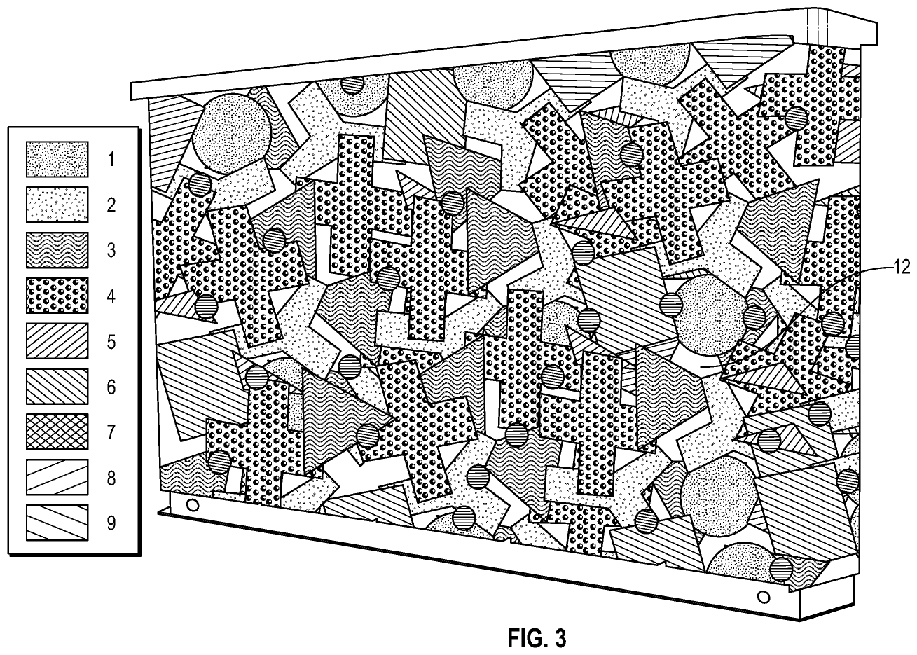

FIG. 3 illustrates an example of camouflage artwork 12 when applied to electrical infrastructure. The artwork is multi-faceted digital artwork that can be produced in any size and scale. The concept was to use many colours so irrespective of the spray pack or marker being used, the colour would already be represented in the artwork. This greatly diminishes visibility of the tagging when applied. The shapes are irregular and mostly larger than in FIG. 2. In this version the reds and blues predominate in the original-coloured artwork.

### EXAMPLE 2a

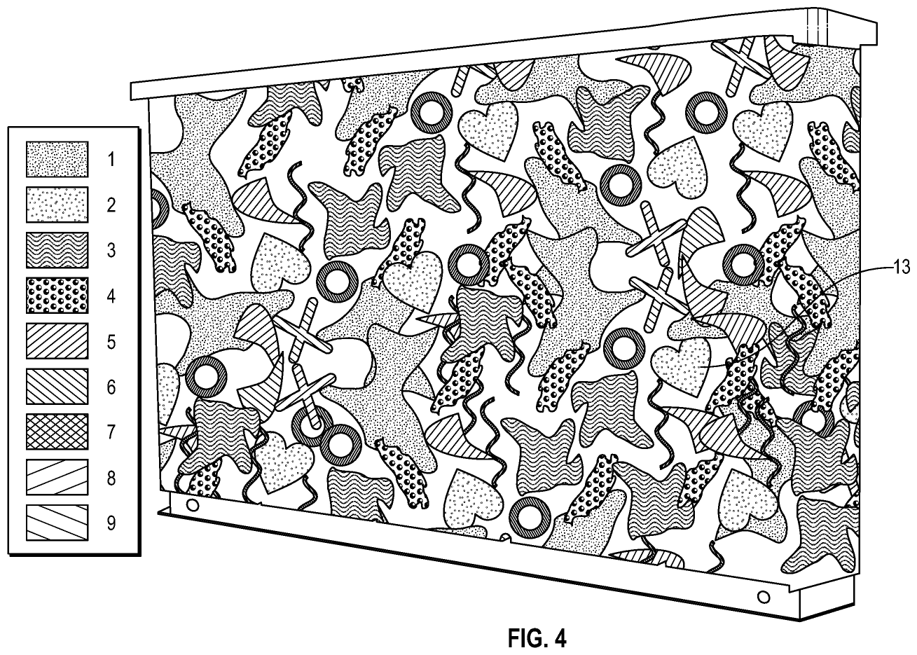

FIG. 4 illustrates another example of camouflage artwork 13 when applied to an electrical infrastructure. The artwork is multi-faceted digital artwork that can be produced in any size and scale—and these illustration were produced virtually by applying the artwork to overlay the graffiti shown in FIG. 1 (as the electrical infrastructure box is the same in all views but with the artwork varied). In this version the yellow and white areas predominate in the original artwork.

By way of example the majority of pixels can have a minimum area of 200 sq. mm. However, any one pixel in isolation may not equal 200 sq. mm as the size of the pixel is relative to the size of the artwork.

The majority of pixels can be between 200 sq. mm and 10,000 sq. mm in area (i.e. up to 1/100^{th} of a sq. m.) and in most cases the majority of pixels are of a different colour to the majority of their adjoining pixels.

In order to produce the Inventive concept artwork, a variety of methods can be used. One method is to use computer software to design and create the artwork, which can then be printed onto adhesive vinyl wraps or similar material. The artwork is then cut to size and applied to the surface of the object to be protected. It can be repeated along the length of a roll of waterproof material, e.g. printed onto a vinyl roll. Preferably the artwork should be pleasing to the eye whilst at the same time having a sufficient collection of coloured pixels that it effectively absorbs any subsequently applied graffiti and renders it far less visible or legible than the tagger intended. The artwork also incorporates design elements that are similar to graffiti. These are intended to further camouflage any tagging and remove any motivation for tagging the object.

Initially trials were based on printing onto an adhesive vinyl covering that is best suited to smaller areas, the intention was that it would be scalable so that it can also be applied to very large surfaces. That vinyl covering could also be provided with other layers, preferably a transparent peel off film, so that anything sprayed over the artwork could also be removed in the conventional peel off manner.

Another option is to use stencils or templates that simplify the application of the artwork onto very large areas quickly and far more cost effectively than custom artworks.

### EXAMPLE 3

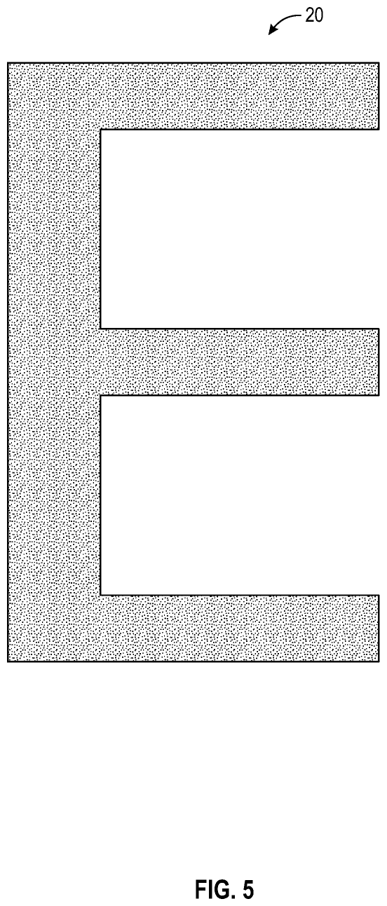

FIGS. 5 to 7 show the effect of adjoining pixels. In the spreadsheet FIG. 5 shows the letter E (designated by the numeral 20) originally shown in yellow on a plain background.

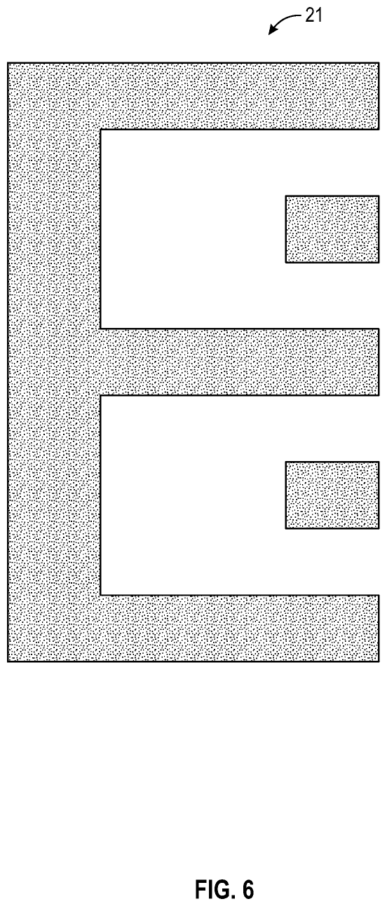

FIG. 6 has a backdrop of rectangular cells each containing a different colour but with only the cells coloured “yellow” shown (for simplicity), alongside an overlay of the letter E (20) applied by a tagger. In this simplistic illustration (assuming the other cells provide a contrasting background to the yellow colour—which is not likely to be the case in practice) the letter E is now partly disguised (21) by the pre-existing yellow-coloured cells—i.e., the letter E is now less readily identified as it merges with the existing yellow arrangement of cells.

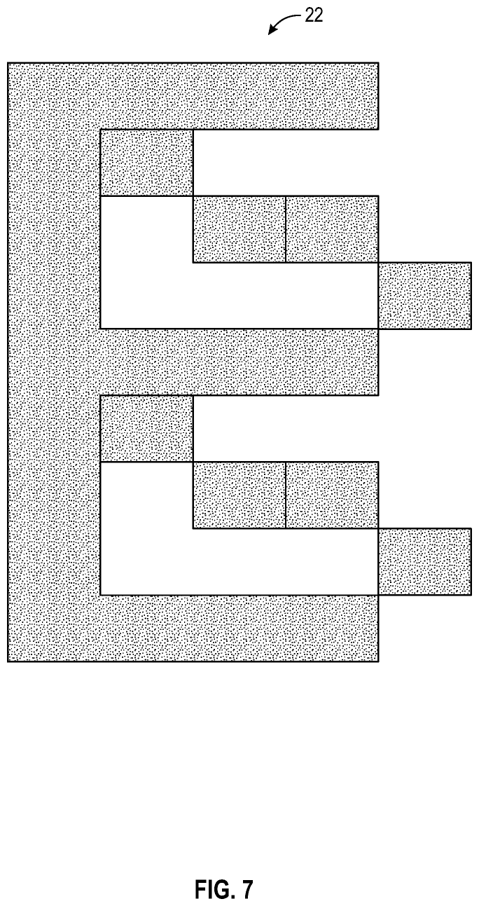

This is even more marked in FIG. 7 where the differently coloured cells are staggered so that the adjoining yellow cells detract from the identifiability of the letter E to the left of the figure, so that the resulting shape 22 is difficult to recognise as the letter E.

If the majority of pixels has a width equivalent to the width of letters applied by a tagger using a spray can or brush (say 50 mm) then a portion of a letter will disappear inside that pixel if it is the same or similar colour to that of the pixel. The surrounding pixels not covered by the tag will also detract from the visibility/legibility of the tag if they are of the same or simar colour to that applied by the tagger.

In most cases taggers will use only one or two colours when applying a tag. So, by using a plurality of colours (preferably the 8 colours of the rainbow plus white and black,) it is possible to make it difficult for the tag to stand out from the camouflage background (as the colour(s) to be used by the tagger is unknown). The palette of colours on the colour schemes of this invention can be linked to the colour palettes of available spray paint cans, as these can differ from manufacturer to manufacturer.

Whilst it is possible to use pixelated images/photographs this is unlikely to satisfy the criteria of having the majority of adjoining cells of different colours. For example, a pixelated image of a face to disguise a person's identity is likely to have too many flesh-coloured pixels.

### EXAMPLE 3a

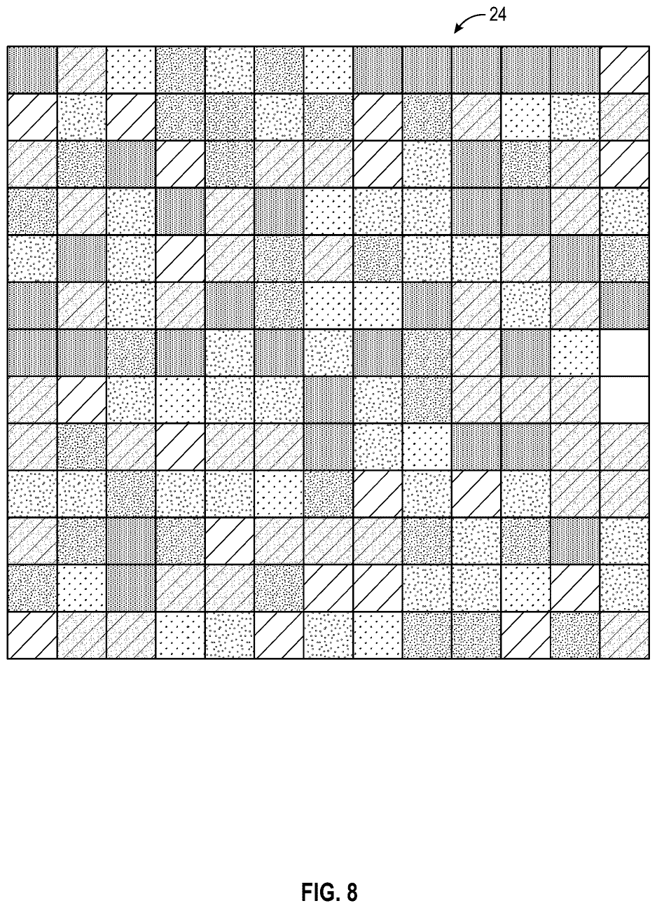

It is better to use a collection of randomly coloured square pixels 24 as shown in FIG. 8. In this figure the majority of adjoining square shaped pixels are of different colours but some of the same colour may adjoin one another to create random shapes.

### EXAMPLE 4

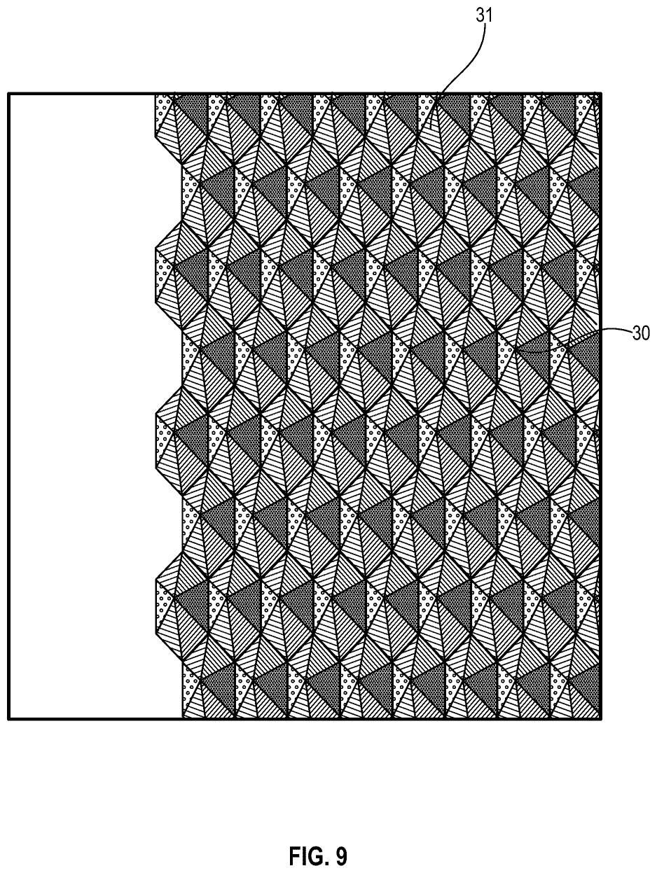

FIG. 9 shows an alternative approach in which 3D “pixels” ((called “3D artworks”) which may be in the form of applied protrusions 30 or depressions 31 are used to break up the surface making it harder for a tagger to produce a legible tag or other mark. Only part of the tile is shown covered with tessellations to help highlight the hexagonal pyramidal shapes along the left boundary of the tessellations. But in practice the entire surface area would be covered with these shapes to make it more difficult for a tagger, especially when viewed form an oblique angle as part of the tag will be in shadow. By slanting the surfaces of the majority of pixels in different directions-even if the tagger can apply paint-it is more difficult to make out the tag -rendering the exercise useless from the tagger's point view. These 3D artworks can be modular e.g., tiles of 1 m×1 m in area (from pressed Aluminium) so they can be scaled and connected and applied to any surface of any size, or as shown in this figure can be tessellations moulded into the exterior of a concrete wall. The formwork can be a “negative” of the tile shown in FIG. 9 so that hexagonal peaks can be moulded in to the concrete and the formwork removed.

### EXAMPLE 5

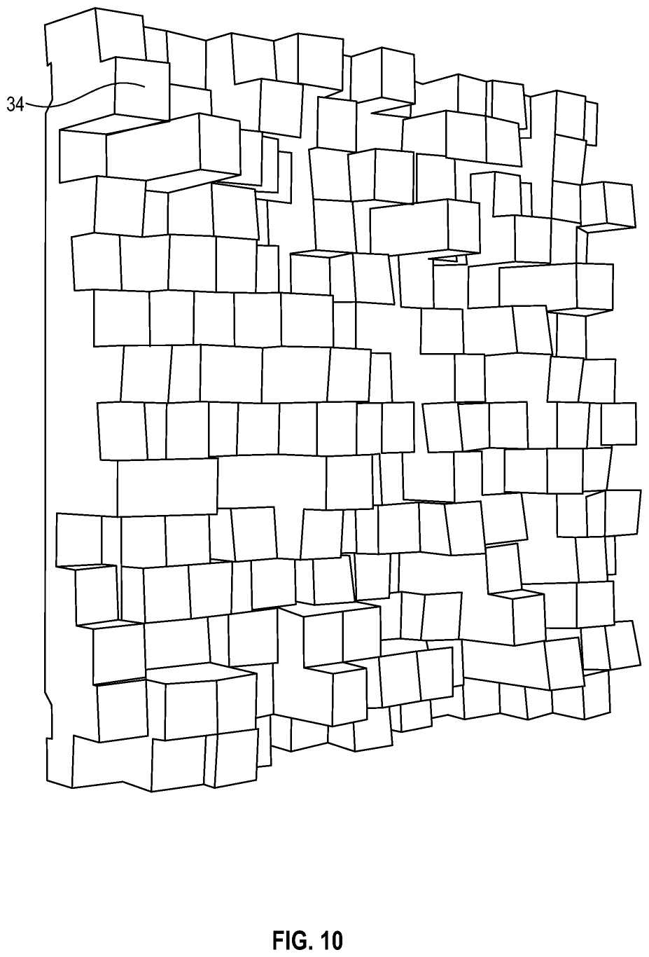

FIG. 10 shows a tile made up of regular primarily rectangular shapes 34 but of different heights (i.e. the dimension extending outwardly from the underlying surface) to make it hard for a tag to be visible (especially from a side angle as parts of a letter will be shadowed by the protruding portions of the applied tile as there is no longer a large enough planar backdrop for the placement of graffiti. This could be a moulded plastics tile or a pressed metal tile. If this design is considered for a moulded concrete surface the “rectangular bricks” may need to be tapered to allow release of the formwork.

By way of example the blocks could be from 60 mm to 80 mm (viewed face-on) and of varying heights up to 160 mm above the plane of the back of the tile. This gives a face area per block of 4,800 sq. mm which is considered to be sufficient to break up the intended visibility/legibility of any later applied graffiti. These dimensions are not intended to be limiting but only to aid the understanding of the invention.

### EXAMPLE 6

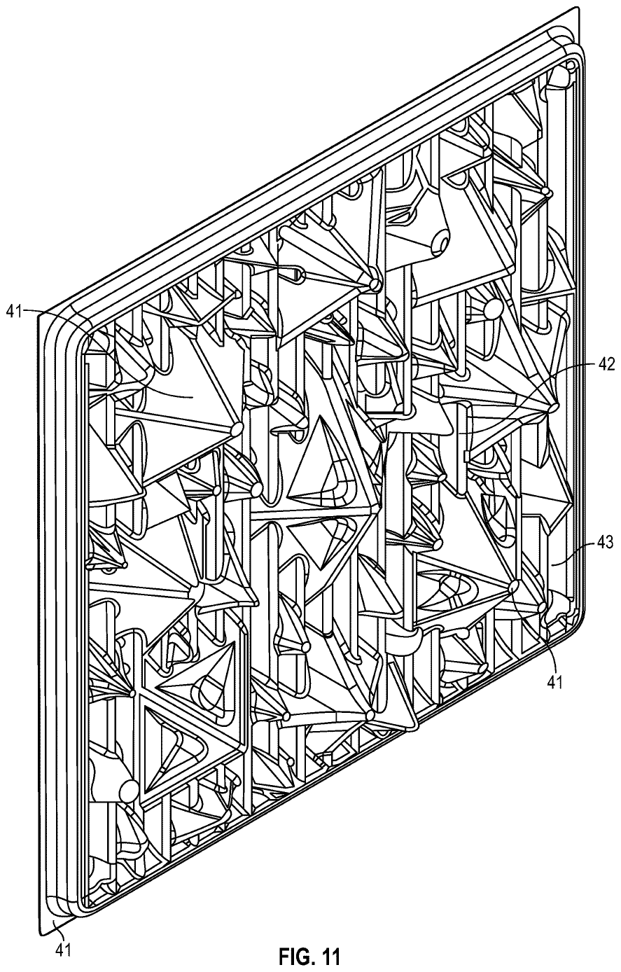

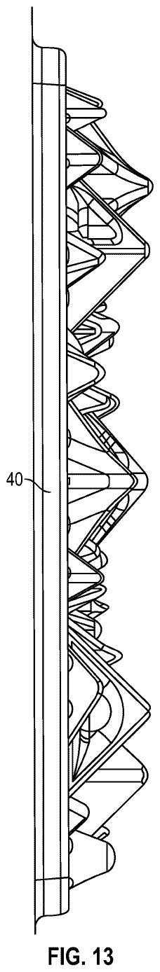

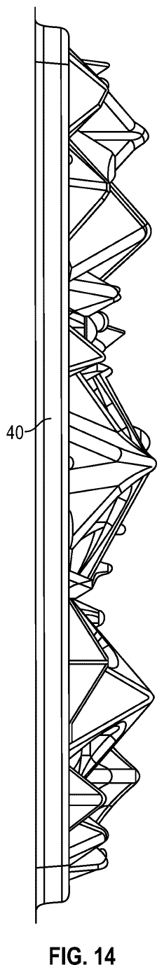

The tile 40 of FIGS. 11-14 has been designed as a 3D tile designed to be secured to the outside of a wall, a building, or a structure. Typically such a tile will be approximately 1m×1m in size, to provide coverage, particularly for sound barriers alongside motorways. Such sound barriers are typically made of concrete though some are made of plastics. If the tile is to be used away from buildings, it can be formed of a plastics material, which preferably is UV and weather resistant, and can be secured to say a sound barrier in any convenient way, using bolts, screws, or in some cases industrial strength adhesive. A suitable plastics material for the tile is polypropylene.

As a moulded 3D plastics tile it will typically be produced in a single colour, relying on the 3D pixels to break up or obscure the graffiti or otherwise make it hard to see, particularly when not viewed from head on.

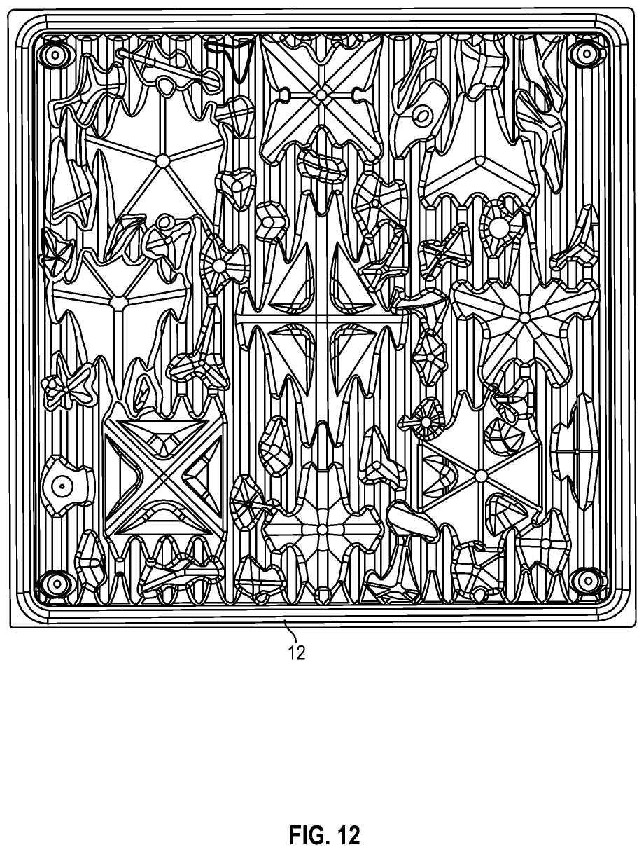

By way of example the varying shapes of the 3D pixels could have a “face area” of 400 sq. mm approximately up to 100,000 sq. mm of the base of the larger shapes (viewed face-on as in FIG. 12) and of varying heights up to 200 mm above the plane of the back of the tile. These dimensions are based on the 1 m by 1 m plastic prototype tile shown in FIGS. 11 to 14.

These suggested 3D pixel sizes may vary as further testing may show that fewer but larger shapes per square metre may prove more effective or are more practical for coverage of larger areas. This may mean the shapes are bigger than they are currently designed.

If very small protrusions are used it is preferred that they have a minimum face area of 200 sq. mm. In practice these irregular shapes favour larger faceted face areas. Because they are irregular shapes it is difficult to define their size or face area so these terms are best applied to the base of each protrusion as if they were mountain peaks rising above a plain. This gives a “face area” per irregular shape of from 200 sq. mm to 100,000 sq. mm which is considered to be sufficient to break up the intended visibility/legibility of any later applied graffiti, noting that many of these shapes have faceted faces each of which is smaller in area than the overall area of the protrusion or depression. These dimensions are not intended to be limiting but only to aid the understanding of the invention.

If it is to be attached to a building then it is preferable that it is press formed from a suitable metal. Depending upon the country, fire safety regulations may prohibit the use of a plastics material to be secured to a habitable building but may allow for a ceramic or metal cladding. Given the complexity of the shape, a press formed metal tile may be a suitable substitute for a moulded plastic tile. It is preferred that the 3D shapes form an overall irregular external surface, both making it difficult for a tagger to produce a legible tag because of the irregular exterior of the tile, and that even if spray-painted, the tag will be hard to see particularly from an angle. It been recognised that the tag might be visible if viewed face on but the purpose of tagging is to create a sign which can be seen not only face on but from a wide range of angles, and in this case if the tag is applied to one or more of the tiles affixed to a wall such as a motorway sound barrier, the tag will not be visible from a wide range of angles because parts of the tag will be hidden by the protruding portions of the exterior surface of the tile.

It is also desirable that the shapes used on the exterior of the tile especially when intended for the exterior of building that the shapes make it difficult for someone to gain a foothold hence the sloping shapes shown in FIG. 11.

It is preferred that each tile has an irregular collection of shapes (although they may repeat along a wall if a number of similar tiles are attached to the wall. In this example the tile has a number of peaks 41 of different heights as well as ribs 42 and depressions or valleys 43.

The different heights and irregular nature of the shapes can best be appreciated from FIGS. 12 to 14.

The irregular collection of 3D shapes, for example that shown in FIG. 11, can also be used in a mould for the casting of concrete panels for use in concrete walls, for example the concrete sound barriers used alongside motorways. Concrete surfaces are often vulnerable to tagging and graffiti, and by providing an irregular collection of 3D shapes in the exterior surface of the concrete wall, this makes it less likely that tagging will be applied to the concrete wall, and even if apply it is applied, it will be less legible, and therefore less obtrusive.

These figures show a tile having a “three-dimensional outer surface” with various raised portions and depressions, designed to make it difficult for a graffiti artist to produce a legible tag. By creating an irregular contour over the surface of the tile, the overall effect of the tile or a plurality of tiles affixed to a structure is pleasing but it eliminates any monochrome flat surface, and thus, any attempt to apply graffiti to one or more of the tiles defeats the purpose of the graffiti artist because the contours of the graffiti or tag will be broken up by the irregular contour of the tiles.

In this and the following 3D examples it is preferred that that the majority of pixels have a minimum surface area of 200 sq. mm. More preferably the majority of 3D pixels are between 200 sq. mm and 100,000 sq. mm in surface area. Also the peaks of the highest protrusions are about 200 mm in height for a tile of 1 m by 1 m (about ⅕^{th} of the length of each side).

### Example 7

The tile of FIG. 11 can also be manufactured as a pressed metal tile, e.g. an aluminium tile which can be affixed to the outside of a building or other structure. It can be powder coated if desired in a selected colour as part of the manufacturing process. Multi-colours could be applied if ordered in volume, though such pressed metal tiles will rely primarily on the 3D shapes to break up the graffiti.

### EXAMPLE 8

The tile of FIG. 11 can also be manufactured as a moulded concrete or ceramic tile, which can be affixed to the outside of a building or other structure.

### EXAMPLE 9

Instead of producing a separate tile the 3D cluster shown in FIG. 11 (or a similar arrangement) can be applied to the exterior of a precast concrete panel. This involves using the tile of FIG. 11 to make a negative mould and then using that negative mould to mould the exterior of a concrete panel so that the resulting panel has at least one exterior face showing the cluster of 3-D shapes appearing in the tile of FIG. 11.

Taggers prefer to apply tags or graffiti to monochrome substantially flat surfaces, as this enhances the legibility and visibility of the tag over substantial distances. Examination of tags applied to buildings or to freestanding structures shows that the majority of tags have a minimum height of 1 m And a minimum width of 0.5 m. For example, tags are often applied to walls or bridges where there is a large, flat surface, which the tagger believes they can use as the backdrop to their tag.

The cost of removing tags or over painting them, is a substantial maintenance cost, and it is better if at all possible to deter taggers from applying tags or other graffiti in the first place. The purpose of this invention is to provide means for deterring the application of tags or graffiti to a building or structure by making it difficult for any applied tag to be legible or visible. The invention achieves this by applying a covering to at least part of the building or other structure where tagging or graffiti is expected, the covering being designed to make it difficult for a tag or other graffiti to be visible by using a multicoloured approach to destroy the outline of the tag or other graffiti or by covering the flat surface with a contoured tile.

The key concepts of the 2D aspects of this invention are:
The artwork needs to be able to be created in any size and still be logical in its representation.
It should be multi-coloured where practical and limit the use of blocks of solid colours in the artwork.
It should also contain shapes and other elements that would further disguise any graffiti were the artwork to be vandalized.

While this or similar artwork may reduce the risk of graffiti, the artworks may not be well received by the broader community because of their bold colours and design elements. They are also unlikely to “fit” in any non-contemporary setting and could be visually overwhelming when applied at scale.

Guidelines for producing different artwork in accordance with this invention include:

The initial criteria for the artworks would be:
To represent a relevant scene irrespective of the size of the artwork. It is necessary that the artworks could be “cut to size” to suit any manner of applications and sizes. We envisage that the artworks would need to suit surfaces from as small as 0.25 m² to very large areas of 20 m² or more.
The artworks can be printed at scale on adhesive vinyl wraps or similar to allow fast, cost effective and simple application almost anywhere. (it is not practical that each artwork is scaled to suit each specific application as this would require each artwork to be custom printed which would be cost prohibitive)
Multi-coloured while still being faithful to any cultural elements (where incorporated) of the artwork and its importance.
Bright and cheerful and would positively contribute to the amenity of the local area.
Discourage/eliminate graffiti.
In the case of 3D pixels these are best designed and applied at the time of producing a building or a wall.

### ADVANTAGES

An anti-graffiti system that discourages graffiti by rendering most applied tags or other graffiti illegible or unrecognisable as it is disguised by the artwork or shapes covering a building or other object.

### VARIATIONS

It will of course be realised that while the foregoing has been given by way of illustrative example of this invention, all such and other modifications and variations thereto as would be apparent to persons skilled in the art are deemed to fall within the broad scope and ambit of this invention as is hereinbefore described.

Whilst some guidance has been given on pixel sizes as illustrated by the drawings, some pixels can be quite small as the size of the pixel is relative to the size of the artwork. They will scale as the artwork gets bigger, or more pixels of the same colour can be added.

The preliminary prototypes have been formed from a layer of self-adhesive vinyl with coloured pixels printed on the outer surface and a moulded plastics tile as shown on the drawings.

The waterproof plastics substrate could include one or more layers to reinforce the substrate or to protect the printing. For example a transparent peel off film could be used, such as the 3M clear protective film, so that anything sprayed over the artwork could also be removed in the conventional peel off manner.

Other suitable plastics material can be used for the coloured pixels.

In the case of the 3D pixels the tile can be formed of any hard-wearing material including a metal such as aluminium, or a ceramic or a concrete. Whilst they will typically be produced in a single colour they can also be multi-coloured as well to further break up the outlines of any applied graffiti.

The suggested 3D pixel sizes may vary as further testing may show that fewer but larger shapes per square metre may prove more effective or is more practical for coverage of larger areas. This would mean the shapes are bigger than they are currently designed or shown in FIGS. 10 to 14.

1. A method of minimising the risk of graffiti despoiling a surface, the method, including reducing the available area for graffiti by applying pixels (as herein defined) to the surface.

2. A method of minimising the risk of graffiti despoiling a surface as claimed in claim 1, wherein the pixels provide a multi-coloured coating to the surface, made up of coloured pixels (as herein defined) of different colours, so that the application of graffiti to that painted surface will render the applied graffiti as not or not very visible or legible, as the outline of the graffiti will blend in with at least some of the coloured pixels thereby detracting from the visibility or legibility of the graffiti.

3. A method of minimising the risk of graffiti despoiling a surface as claimed in claim 2, wherein the majority of pixels are of a different colour to the majority of its adjoining pixels.

4. A method of minimising the risk of graffiti despoiling a surface as claimed in claim wherein the coloured pixels are applied to a waterproof backing sheet which can be applied to a surface of a building or other object.

5. A method of minimising the risk of graffiti despoiling a surface as claimed in claim 1, wherein the applied pixels are three-dimensional thereby breaking up the flat surface area of the object to render any applied graffiti as not or not very visible or legible.

6. A method of minimising the risk of graffiti despoiling a surface as claimed in claims wherein the majority of coloured pixels have a minimum area of 200 sq. mm.

7. A method of minimising the risk of graffiti despoiling a surface as claimed in claim 6, wherein the majority of coloured pixels are between 200 sq. mm and 10,000 sq. mm in area.

8. A building or other object protected by coloured pixels or 3D pixels applied by the method of claim 1.

9. A product designed to minimise the risk of graffiti despoiling a surface consisting of a waterproof layer to be applied to structure to be protected, the layer having a preprepared exposed/external surface containing a collection of pixels (as herein defined) designed to reduce the legibility/visibility of any applied graffiti.

10. A product designed to minimise the risk of graffiti despoiling a surface as claimed in claim 9, wherein the layer is a flexible plastics layer pre-printed with coloured pixels (as herein defined).

11. A product designed to minimise the risk of graffiti despoiling a surface as claimed in claim 10, wherein the flexible plastics layer has a self-adhesive backing.

12. A product designed to minimise the risk of graffiti despoiling a surface as claimed in claim 9, wherein the layer is a tile having three-dimensional pixels (as herein defined) thereon.

13. A product designed to minimise the risk of graffiti despoiling a surface as claimed in claim 12, wherein the tile is formed of a rigid or semi-rigid plastics material, or a metal, or a ceramic or a concrete.

14. A product designed to minimise the risk of graffiti despoiling a surface as claimed in claim 12, wherein the three-dimensional pixels (as herein defined) are also coloured.

15. A product designed to minimise the risk of graffiti despoiling a surface as claimed in claim 12, wherein a majority of the 3D pixels (as herein defined) have exterior surfaces at an angle to adjacent pixels.

16. A product designed to minimise the risk of graffiti despoiling a surface as claimed in claim 9, wherein the majority of pixels have a minimum area of 200 sq. mm.

17. A product designed to minimise the risk of graffiti despoiling a surface as claimed in claim 16, wherein the majority of 3D pixels are between 200 sq. mm and 100,000 sq. mm in area.

18. A product designed to minimise the risk of graffiti despoiling a surface as claimed in claim 12, wherein the product is a cast concrete panel having a moulded exterior surface having three-dimensional pixels thereon.

19. A mould for a pre-cast concrete panel having a negative pattern of a cluster of three-dimensional pixels capable of being used to cast a concrete panel having a cluster of three-dimensional pixels on an exterior surface thereof.
